(19) United States
(12) Patent Application Publication
(10) Pub. No.: US 2005/0125262 A1
(43) Pub. Date: Jun. 9, 2005

(54) SYSTEM FOR CONSUMER TRAVEL SERVICE CHANNEL INTEGRATION

(75) Inventors: Bion Bartning, to follow, AL (US); Jean Marie Healy, New York, NY (US); Audrey Hendley, Maspeth, NY (US); David P. Jackson, Phoenix, AZ (US); Jennifer Kraft, to follow, AL (US); Denis Perracchio, Peoria, AZ (US); Jarvis J. Slade, New York, NY (US); John Timothy Williams, Jacksonville, FL (US)

Correspondence Address: SNELL & WILMER;ONE ARIZONA CENTER, 400 EAST VAN BUREN, PHOENIX, AZ, 850040001, US

(73) Assignee: AMERICAN EXPRESS TRAVEL RELATED SERVICES, New York, NY (US)

(21) Appl. No.: 10/707,310

(22) Filed: Dec. 4, 2003

(51) Int. Cl. G06F 17/60

(52) U.S. Cl. 705/5

(57) ABSTRACT

An integrated travel channel system that allows users to create, view, modify and/or cancel certain travel bookings regardless of the travel channel used by the consumer (i.e., traveler) to initiate, modify or cancel the travel booking. In this manner, an integrated travel channel system can be provided, in an exemplary embodiment, that allows users to contact a full service travel office using any of a variety of travel channels 24 hours a day, 7 days a week.

### TECHNICAL FIELD

The present invention generally relates to the travel industry. More specifically, the present invention relates to integrated consumer travel channel systems and methods that may be used to process trip requests independent of the travel channel used to originally book the trip.

### BACKGROUND INFORMATION

The last half of the twentieth century, and particularly the last two decades, has been characterized by rapid changes in the travel industry. One example of the changes is the growth of the airline business that has resulted in the proliferation of travel agencies and other entities that provide services for creating and modifying travel bookings. This growth has also led to many technological advancements in the travel industry such that travel bookings can be processed through a variety of consumer travel channels including the Internet, telephone, physical travel offices, e-mail, or even speech recognition systems. Moreover, a full service travel agency may provide consumers with access to a wide variety of travel bookings such as hotel, condominium, rental car, airline, cruises, pre-packaged tours, customized vacations and/or the like. Examples of such full service travel agency providers include American Express. Traditionally, full service travel agency providers provide consumers with a call in center for making and modifying travel bookings.

Unfortunately, the traditional full service travel agency model is often limited in that, if a travel booking is initiated through a particular travel service channel, all subsequent modifications to the travel booking must be executed through the same travel service channel. For example, if a consumer creates a travel booking over the Internet with a full service travel agency, any subsequent travel changes to the same booking typically takes place over that same travel service channel. This is often particularly problematic when consumers are traveling in remote areas of the world where computer access is sporadic or non-existent. Additional problems have typically arisen due to the complexity and cost related to maintaining and integrating hardware and software, especially on those systems where there are multiple computer networks and desktop standards. In addition, there is often a lack of connectivity between travel offices in different locations or between offices that utilize different computer systems.

### SUMMARY OF INVENTION

In accordance with one embodiment of the present invention, a consumer travel channel integration method is provided that includes the steps of providing a host system for facilitating formation of a travel plan and allowing access to the host system by a plurality of travel channels, wherein the plurality of travel channels includes an Internet, a telephone, and a physical travel office. A travel booking for the travel plan is received by a first one of the travel channels and the travel booking is associated with a travel customer. The travel booking information and customer data for the travel customer may be stored in a central repository. A travel change for the travel plan may be received by a second one of the travel channels, wherein the second travel channel is different from the first travel channel. The travel booking information and the customer data is retrieved from the central repository and the travel change is serviced by modifying the travel booking to produce a modified travel booking. The modified travel booking may be stored in the central repository.

### BRIEF DESCRIPTION OF DRAWINGS

A more complete understanding of the present invention may be derived by referring to the detailed description when considered in connection with the Figures, wherein like reference numbers refer to similar elements through out the Figures, and:

FIG. 1 illustrates a schematic diagram of an integrated travel channel system in accordance with an embodiment of the present invention;

FIG. 2 illustrates a schematic diagram of an integrated travel channel system in accordance with an embodiment of the present invention;

FIG. 3 illustrates a schematic diagram of an exemplary network in accordance with the present invention;

FIG. 4 illustrates a schematic diagram of an exemplary point-of-service terminal in accordance with the present invention;

FIG. 5 illustrates a flow diagram of an exemplary process for planning and changing a travel booking in accordance with an embodiment of the present invention; and

FIG. 6 illustrates an exemplary web-site for an integrated travel channel system in accordance with an embodiment of the present invention.

### DETAILED DESCRIPTION

The present invention includes an integrated travel channel system that allows users to create, view, modify and/or cancel certain travel bookings regardless of the travel channel used by the consumer (i.e., traveler) to initiate, modify or cancel the travel booking. In this manner, an integrated travel channel system can be provided, in an exemplary embodiment, that allows users to contact a full service travel office using any of a variety of travel channels 24 hours a day, 7 days a week.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, (e.g., memory elements), processing elements, logic elements, look-up tables, and the like, which may carry out a variety of functions under the control of one or more microprocessors or other control devices. Similarly, the software elements of the present invention may be implemented with any programming or scripting language including, but not limited to, C, C++, Java, COBOL, assembler, PERL, extensible markup language (XML), and Microsoft's Visual Studio .NET, with the various algorithms being implemented with any combination of data structures, objects, processes, routines or other programming elements. Further, it should be noted that the present invention might employ any number of conventional techniques for data transmission, signaling, data processing, network control, and the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development, database operations, and other functional aspects of the system (and components of the individual operating components of the systems) and method may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, and/or a collection of one or more computer program products. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The present systems and methods facilitate the integration of travel channels, and thus information and services between travel offices and between travel counselors at the various travel offices are also integrated. In addition, the systems and methods facilitate integration with the Internet, Global Distribution Systems (GDS)/reservation systems, alternate inventory (e.g., limousine providers), vendor direct systems, and/or other reservation processing technologies (e.g., document delivery, file finishing, trip planning). The GDS includes any computer network that provides travel agents and other travel information groups with inventory access related to, for example, hotel, condominium, rental car, airlines, and/or the like. Examples of such inventory systems include, but are not limited to, the SABRE™ system, Amadeus™, Galileo/Apollo™, System One™, and Worldspan™.

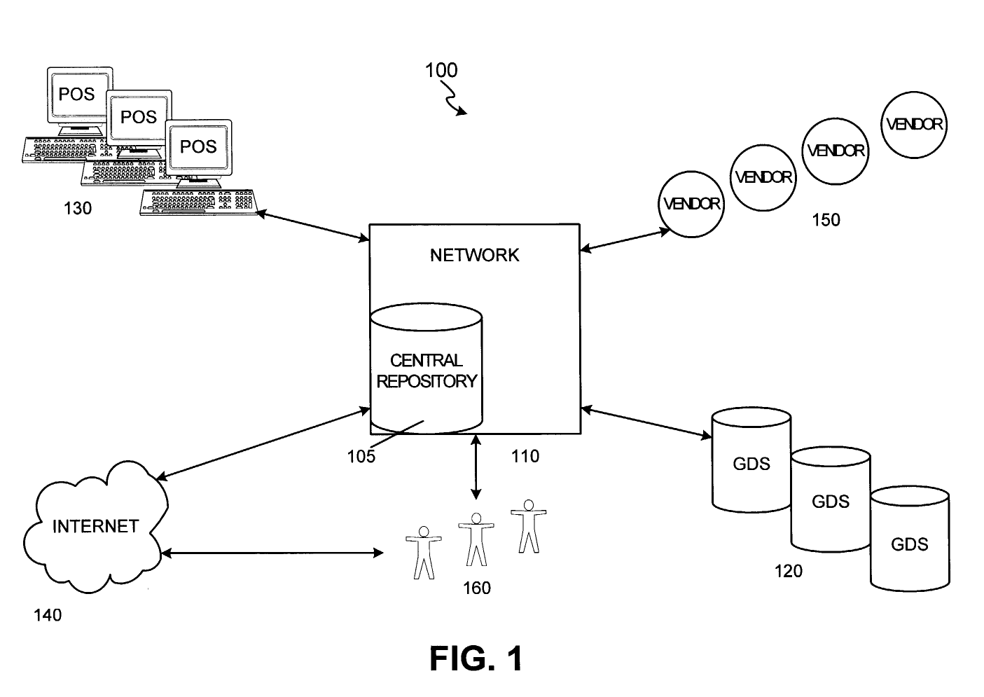

Referring to FIG. 1, the present invention presents an integrated travel channel system 100 which enables users to access travel bookings and customer data in a manner that is fully or partially independent from a particular travel channel or computer system (e.g., a GDS system). This system facilitates technology and business process independence from, or limited dependence on, a particular travel channel or reservation system, thereby achieving a fully integrated travel channel system.

System 100 may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art will appreciate, user computer will typically include an operating system (e.g., Windows NT/95/98/2000/2003/XP, Linux, Solaris, etc.) as well as various conventional support software and drivers typically associated with computers. User computer can be in a home or business environment with access to a network. In an exemplary embodiment, access is through the Internet through a commercially-available web-browser software package.

Communication between consumers (e.g., travelers or their representatives) and users (e.g., travel agents/counselors) of system 100 of the present invention may be accomplished through any suitable travel channel, such as, for example, a telephone (traditional land line or cellular), Intranet, Internet, face-to-face (e.g., at a physical travel office), point of interaction device (point of sale device, personal digital assistant, kiosk, etc.), e-mail, voice recognition system, on-line communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

With continued reference to FIG. 1, in accordance with an exemplary embodiment, travel channel integration system 100 comprises a central repository 105, a network 110, one or more GDS systems 120, and one or more multi-use point of service (POS) terminals 130 located at travel offices and other sites. POS terminals 130 may include any computer or other Internet device including personal computers, workstations, servers, personal digital assistants (PDAs), and the like. The POS terminals may be located anywhere in the world and may be connected to travel network 110 such that the users of the terminals have access to GDS systems and other features of the system as will be described in detail below. The central repository 105 is comprised of one or more databases based on readily available products mentioned below (e.g. IBM DB2). The repository is hosted on one or more database server devices and stores various classes of information related to processed reservations (e.g., where processed—GDS, vendor direct connect, off-line reservation direct with vendor), and other travel related data which would govern or aid management of bookings. The database servers may be located on secured segments of travel network 110 and structured to provide required level of scalability, security, performance, data integrity and other industry best practices for level of capability and availability desired.

Travel network 110 is further configured to provide access to the Internet 140 and to a plurality of travel vendors 150 such as airline databases, car and hotel databases, train and bus databases, frequent flyer systems (e.g., Orbit), and the like. This network enables an open consistent vehicle for all requests to initiate, modify or cancel travel bookings for any type of travel (airline, bus, train, car, etc.) regardless of the travel channel used. Specific information related to the protocols, standards, and application software utilized in connection with the Internet may not be discussed herein. For further information regarding such details, see, for example, Dilip Naik, Internet Standards and Protocols (1998); Java 2 Complete, various authors, (Sybex 1999); Deborah Ray and Eric Ray, Mastering HTML 4.0 (1997). Loshin, TCP/IP Clearly Explained (1997). All of these texts are hereby incorporated by reference.

Travel vendor databases may include databases for travel related services such as airlines, car rental, hotel, train, bus, limousines, and any other travel related service. As used in the system of the present invention, a database may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

With continued reference to FIG. 1, external consumers 160 may be connected directly to network 110, such that the external customers have direct access to the travel network. In this manner, external consumers 160 may access various features of the system as described below.

In accordance with one embodiment of the present invention, travel industry system 100 may provide a suitable website or other Internet-based graphical user interface which is accessible by consumers 160 and other users of the system. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access, Microsoft SQL Server, Oracle, MySQL, Interbase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

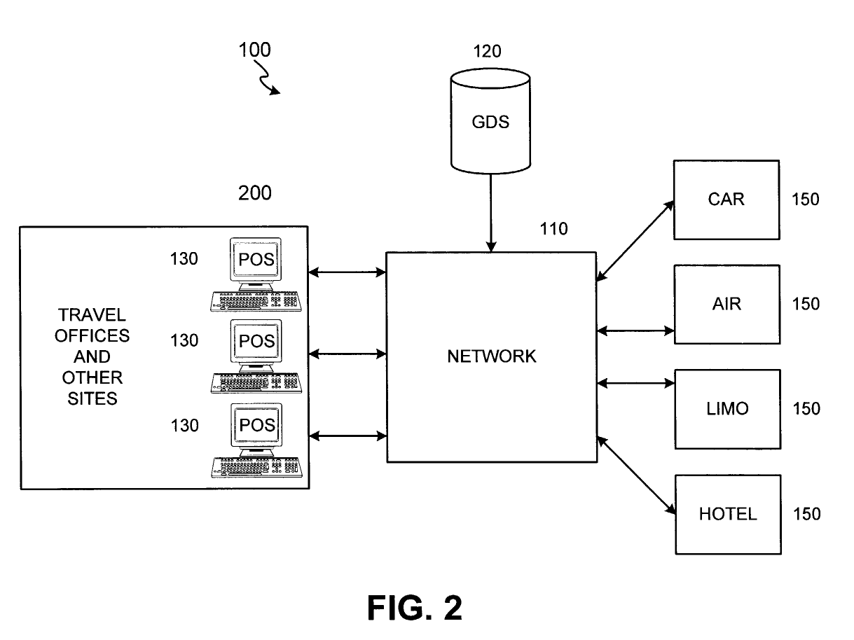

With reference to FIG. 2, in an exemplary embodiment, various components of travel industry system 100 are connected to network 110 such that a centralized connection to network 110 is obtained. For example, GDS systems 120, travel vendors 150, and multi-use terminals 130 at travel offices 200 and other sites may be centrally connected to network 110 such that all users of the multiuse terminals have access to various components of system 100 such as central repository 105, GDS systems 120, and travel vendor databases 150. As used herein, “connected” may include any coupling of systems or components using any suitable software and/or hardware for communicating or transmitting data.

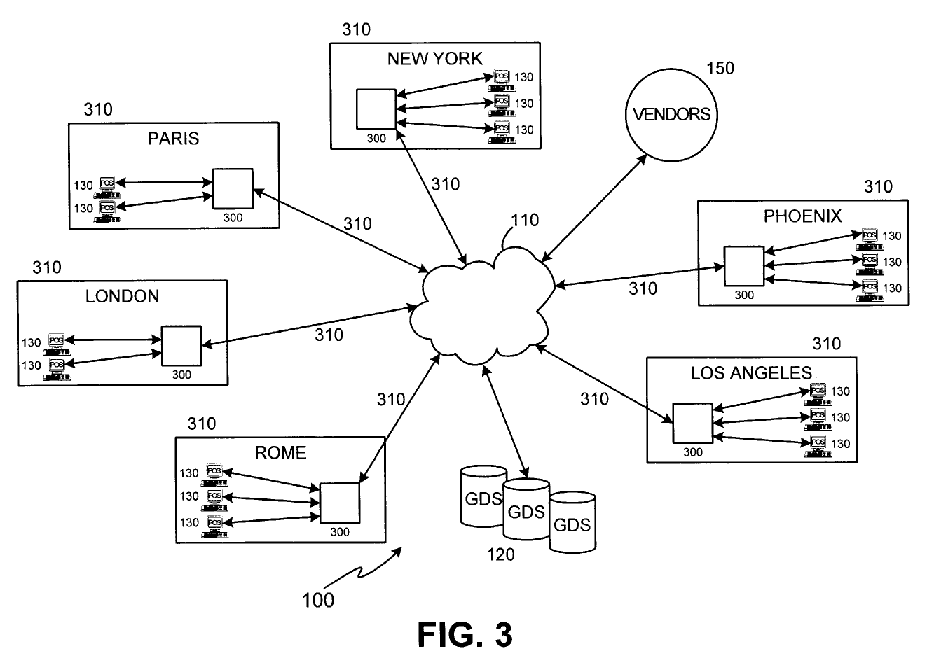

For example, as illustrated in FIG. 3, there may be travel offices 310 in New York, Phoenix, Los Angeles, Rome, London, and Paris. It will be appreciated that these locations 300 are for exemplary purposes only, and that the present invention is of course not limited to these locations. Travel network 110 includes an integrated network such that any user in any travel office in any city can access travel bookings and/or customer data regardless of the travel channel used to initiate, modify or cancel the travel booking. In contrast, previous systems included separate networks and thus users could not access all travel bookings unless the same travel channel was used to initiate and modify a travel booking.

In an exemplary embodiment, a plurality of GDSs 120 are connected to network 110. By connecting a plurality of GDS 120 to the network, the system includes a robust centralized point of contact with all GDSs, as opposed to maintaining separate networks for each GDS depending upon the type of travel channel used or upon the type of travel booking (i.e., cruise, packaged tours, etc.).

Travel vendors 150 may also be connected to network 110. Connections to various vendors (e.g., air, car rental, hotel, rail, limousines, cruise lines, conference centers, ferries) make it possible for travelers to utilize a broader range of travel service choices. The present invention also includes alternative supply and distribution channels for products and services which may be provided by connecting a vendor into network 110. Alternatively, travel vendors 150 may be accessed via the Internet as described below.

In one embodiment of the present invention, the system includes a central connection to all GDS and travel vendors. The system may communicate with the various GDS and travel vendors through a centralized component, such as a translation server. The translation server may communicate natively with the various GDS and travel vendor systems by utilizing an application programming interface (API) supplied by the GDS/travel vendor. Alternatively, the translation server may communicate with the various GDS and travel vendor systems by utilizing an industry accepted standard such as the Open Travel Alliance (OTA) standard. The translation server may also communicate with the rest of the travel industry system 100 by using any standard communication protocol such as the extensible markup language (XML). Clients of the system can change or add GDS vendors without the need to add or replace hardware. In an exemplary embodiment of the present invention, the system includes minimal or no GDS-supplied hardware and allows a company to respond to technology or product improvements with minimal or no GDS approval, thereby providing for a host independent of individual GDSs.

In addition, if a new travel office is to be deployed, the travel office may be connected to network 110 as described below. Easy connection allows for a short time to market for a new travel office. Each travel office may have one or more terminals 130 that provide user access to the system 100 through network component 300. In accordance with one aspect of the present invention, network components 300 are connected to network 110 by network connections 310. Network connection 310 may be any type of suitable network connection such as T1, ATM, ISDN, and/or the like. Terminals 130 may have access to the various GDSs and travel vendor databases through the network connections. The multi-use terminals 130 may be used to provide a single source for accessing multiple GDSs and travel vendor databases for users (travel counselors). These multi-use terminals provide travel counselors with a user-friendly, browser-based Point of Service tool that can be used for servicing customers as described in detail below. Travel counselors will only need to be trained on a single computer user interface/software application in order to be able to service consumers that make contact through a variety of travel channels. Stated another way, multi-use terminal 130 will be operated the same or substantially the same way, no matter which travel channel is used to contact the travel counselor user. In this manner, the terminals 130 of the system provide for a user-friendly operation.

It will be appreciated that many applications of the present invention could be formulated. One skilled in the art will appreciate that network 110 may interface with any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris, Windows XP, or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

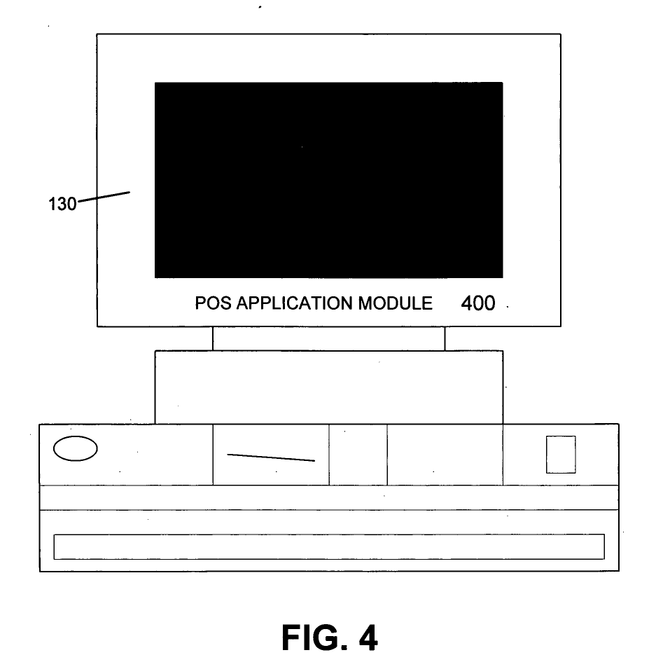

Referring now to FIG. 4, point of service (POS) terminal 130 includes a travel counselor browser based point of service application that is travel channel and GDS independent. It should be appreciated that this streamlines the reservation process and provides for greater operational efficiencies and higher levels of customer service. POS terminal 130 comprises a plurality of trip planning modules 400 that may be used by the travel counselor to initiate, view, modify and cancel travel bookings. These modules can be implemented with software and hardware components.

The user (travel counselor) may use POS terminal 130 to process a request for a travel booking from a traveler. The request may include travel information that relates to the requirements or other desired information for the travel booking. For example, the travel information may include the starting point and destination (or destinations) for travel, dates of travel, preferred time of day for departure and arrival, mode of travel (e.g., air, train, bus, rental car, boat, and the like), hotel requirements (e.g., size of room, smoking/non-smoking, price range, location, etc.), rental car and/or limousine requirements (e.g., size, type, smoking/non-smoking, etc.), and the like. It will be appreciated that the travel information may vary from one trip request to another, as for example, a rental car may be desired for one trip, but not desired for another trip. As another example, one trip may include a same day departure and return, and thus no hotel is desired.

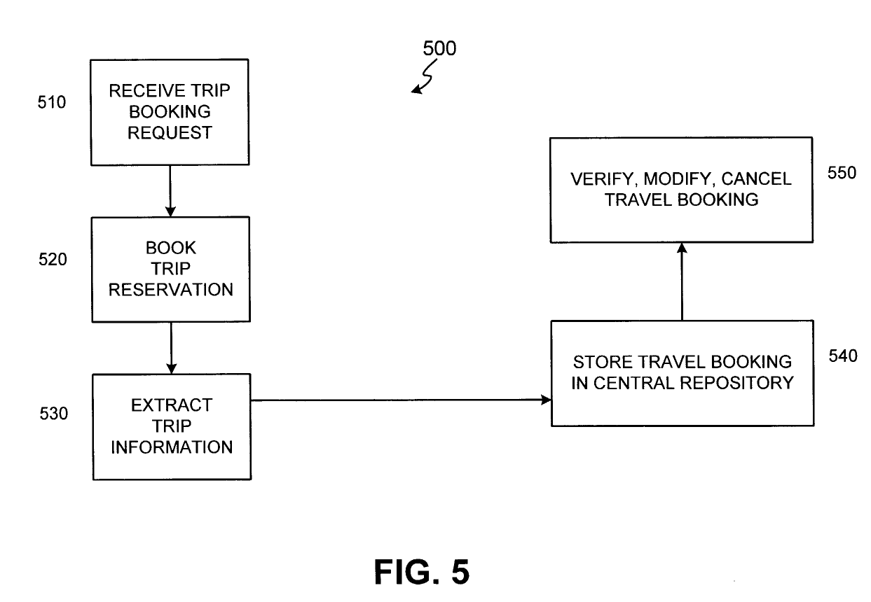

With reference to FIG. 5, an exemplary process 500 using a POS terminal 130 is illustrated for processing a request for a travel booking that is received from a traveler. The travel booking request may be received from the traveler (step 510) by various travel channels. In accordance with one aspect of the present invention, the traveler, or a representative for the traveler (e.g., assistant, secretary, co-worker, employee, travel coordinator, relative, friend, and the like) may access a web site that is associated with travel channel integration system 100. In accordance with one aspect of the present invention, the traveler may register with the web site before making the travel booking request. Alternatively, the traveler may use another travel channel such as calling the travel counselor, physically meeting with the travel counselor in a face-to-face meeting, e-mailing the travel counselor, or utilizing a voice recognition system.

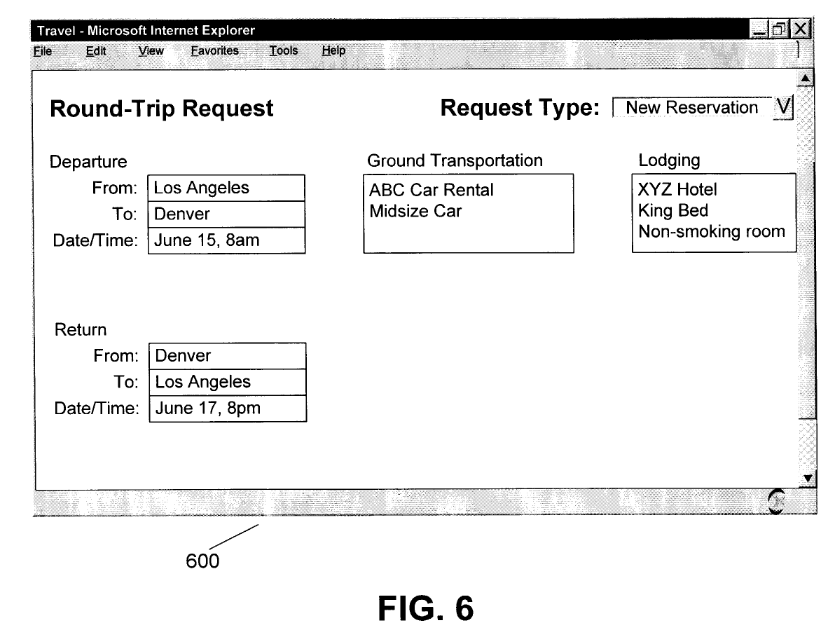

With momentary reference to FIG. 6, an exemplary website 600 is illustrated that contains various fields for entering travel information for the travel booking request. Using an internet browser (e.g., Microsoft Internet Explorer or Netscape Navigator) or a software application (e.g., Microsoft Outlook), the traveler or the traveler's representative may access the web-site and fill out the various fields in the web-site by providing various travel information. It will be appreciated that the user/traveler may execute a travel booking request or modify an existing travel booking by utilizing any travel channel. For example, the traveler may be able to use a web kiosk at an airport to execute a travel booking request. Alternatively, the traveler may be visiting a relative in a particular city or at another location where they only have access to a telephone by which they can contact a travel counselor and modify a travel booking. However, as long as the traveler can access any travel channel, they can execute a travel booking request or submit a request that modifies, cancels or overrides a previous travel booking. In accordance with one aspect of the present invention, the travel booking request may be e-mailed to a pre-existing identified e-mail account. Alternatively, the travel booking request may be executed by the Internet, by telephone, by a face-to-face meeting, by leaving information with a voice recognition system that is used to process the traveler's request for a travel booking or by any other interface.

Once a travel booking request is received by the travel counselor, the travel reservation may be booked. (step 520) The trip information may be extracted from the travel booking request and used to complete the travel booking. (step 530) In accordance with one aspect of the present invention, the travel booking may be stored in central repository 105. (step 540) A travel counselor, utilizing terminal 130, may then view the travel booking information in order to modify, cancel, or otherwise access the travel booking. (step 550)

In accordance with an alternative embodiment of the present invention, the travel booking request may be processed without traveler or travel counselor intervention. For example, if the travel booking request is executed via the Internet, the trip information may be extracted from the travel booking request form and processed automatically. In this manner, the travel booking request may be processed without the need for or with minimal human intervention.

In accordance with another alternative embodiment of the present invention, the traveler may submit a travel booking request by an unformatted e-mail message that may be generated by the traveler using an e-mail client (e.g., Microsoft Outlook). The unformatted e-mail message may be received and presented to a travel counselor. The travel counselor may then proceed to process the travel booking request using the information in the e-mail.

Central repository 105 comprises a database system that stores travel reservation information. The database system may be implemented with any of a variety of well known database standards such as Oracle™, Sybase™, and the like. The stored travel reservation information includes information for a particular trip reservation such as specific flight reservation information, hotel reservations, car rental information, and the like. In addition, central repository 105 may store information for a traveler's contact history with a travel office. For example, the names of travel counselors who assisted the passenger may be stored in central repository 105. The central repository 105 module may also store fulfillment information that indicates which tickets were issued to the passenger and how much the passenger has been charged for the various reservations. It should be appreciated that storing the travel reservation details in a central repository promotes travel channel and GDS independence. In addition, the central repository provides for consolidated storage of itineraries booked through multiple or direct vendors.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A consumer travel channel integration method, comprising the steps of:
providing a host system for facilitating formation of a travel plan;
allowing access to the host system by a plurality of travel channels, wherein the plurality of travel channels includes an Internet, a telephone, and a physical travel office;
receiving a travel booking for the travel plan by a first one of the travel channels;
associating the travel booking with a travel customer;
storing the travel booking and customer data for the travel customer in a central repository;
receiving a travel change for the travel plan by a second one of the travel channels, wherein the second travel channel is different from the first travel channel;
retrieving the travel booking and the customer data from the central repository;
servicing the travel change by modifying the travel booking to produce a modified travel booking; and
storing the modified travel booking in the central repository.

2. The method of claim 1, further comprising the step of connecting a plurality of travel vendor databases to the host system.

3. The method of claim 1, further comprising the step of providing direct access to the host system for a plurality of external consumers.

4. The method of claim 1, further comprising the step of providing a plurality of travel offices, wherein each of the travel offices has access to the host system by said plurality of travel channels.

5. The method of claim 1, wherein the step of receiving a travel booking comprises receiving a travel booking by an unformatted e-mail message.

6. The method of claim 1, wherein the step of receiving a travel booking comprises receiving a travel booking by an Internet travel booking request, and further comprising the step of automatically processing the travel booking request.

7. The method of claim 1, wherein the travel booking comprises flight reservation information, hotel reservation information, and car rental information.

8. The method of claim 1, further comprising the step of storing fulfillment information in the central repository for the travel booking.
